(19) United States
(12) Patent Application Publication
(10) Pub. No.: US 2005/0019558 A1
(43) Pub. Date: Jan. 27, 2005

(54) Coated ferromagnetic particles, method of manufacturing and composite magnetic articles derived therefrom

(76) Inventors: Amitabh Verma, Bangalore (IN); Luana Iorio, Clifton Park, NY (US); Krishnamurthy Anand, Bangalore (IN); Kanchan Kumari, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/627,161

(22) Filed: Jul. 24, 2003

(51) Int. Cl. B32B 15/02; B32B 15/04; B22F 3/02; B22F 3/12

(52) U.S. Cl. 428/336; 428/403; 428/404; 428/407; 419/64

(57) ABSTRACT

A composition comprises ferromagnetic particles having a magnetite coating. In one embodiment, a method comprises coating ferromagnetic particles with magnetite; and compacting the particles to a desired shape. In yet another embodiment, an article is manufactured from a composition comprising ferromagnetic particles having a magnetite coating. In yet another embodiment, an article is manufactured from a method comprising coating ferromagnetic particles with magnetite; and compacting the particles to a desired shape.

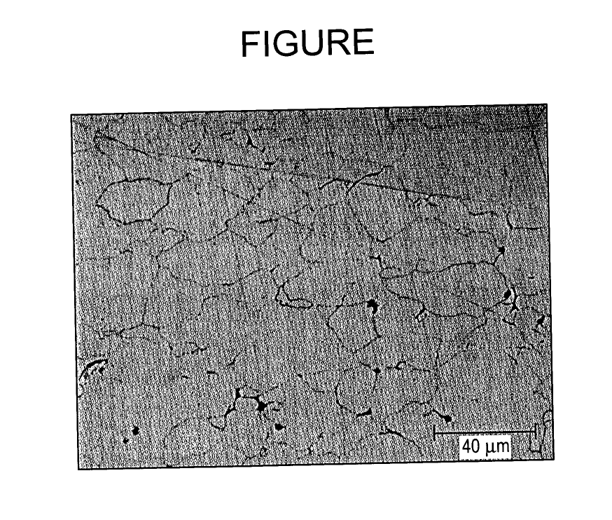

### BACKGROUND

This disclosure relates to coated ferromagnetic particles, methods of manufacturing and composite magnetic articles derived therefrom.

In electromagnetic devices containing soft magnetic materials, the magnetic permeability and core loss characteristics are important properties of soft magnetic materials. Magnetic permeability is a measure of the ease with which a magnetic substance may be magnetized and is an indication of the ability of the material to carry a magnetic flux. Magnetic permeability is defined as the ratio of the induced magnetic flux to the magnetizing force or the magnetic field intensity. The exposure of a magnetic material to a rapidly varying field results in an energy loss in the magnetic core of the material; this energy loss is known as the core loss. Core loss is divided into two categories, hysteresis loss and eddy current loss. The hysteresis loss results from the expenditure of energy to overcome the retained magnetic forces in the magnetic core. The eddy current loss results from the flow of electric currents within the magnetic core induced by the changing flux.

Electromagnetic devices generally use a magnetic core made from laminated structures. Laminated cores are typically made by stacking thin ferrous sheets which are oriented parallel to the magnetic field to provide low reluctance. The sheets may be coated to provide insulation and prevent current from circulating between sheets. Such insulation results in a reduction in the eddy current loss. The fabrication of such laminated cores is generally an expensive process. In addition, the application of laminated cores is limited by the need to carry magnetic flux in the plane of the sheet to avoid excessive eddy current losses. Laminated cores experience large core losses at high frequencies and are acoustically noisy as the laminations have a tendency to vibrate.

It is, therefore, desirable to produce electromagnetic devices having high permeability and low core loss characteristics in a cost-effective manner.

### BRIEF DESCRIPTION OF THE INVENTION

A composition comprises ferromagnetic particles having a magnetite coating.

In one embodiment, a method comprises coating ferromagnetic particles with magnetite; and compacting the particles to a desired shape.

In yet another embodiment, an article is manufactured from a composition comprising ferromagnetic particles having a magnetite coating.

In yet another embodiment, an article is manufactured from a method comprising coating ferromagnetic particles with magnetite; and compacting the particles to a desired shape.

### BRIEF DESCRIPTION OF DRAWINGS

The FIGURE represents the microstructure of compacts made using magnetite coated iron particulates.

### DETAILED DESCRIPTION OF PREFERRED EMBODIMENTS

Disclosed herein are high magnetic permeability, low-core loss soft magnetic compositions, composites derived therefrom, and methods for manufacturing articles from these soft magnetic composites. These soft magnetic compositions comprise ferromagnetic particles that are coated with an electrically insulating coating comprising magnetite (Fe₃O₄). The thin, continuous coating encapsulates the ferromagnetic particle and further separates and insulates them from each other. The coated particles may advantageously be molded to any desired shape to provide a rotor or stator having a high magnetic permeability, high saturation three dimensional flux capabilities and low core loss. These features make the coated soft magnetic composites useful in electrical motors and the resulting shapes can be advantageously used to replace laminated structures in other commercial applications as well.

As stated above, the ferromagnetic particles are covered with a coating. It is generally desirable for the coating to be a conversion coating. A conversion coating as defined herein is formed by a chemical reaction with the parent ferromagnetic particles, which is then converted into a coating. The ferromagnetic particles may have shapes whose dimensionalities are defined by integers, e.g., the particles are either 1, 2 or 3-dimensional in shape. They may also have shapes whose dimensionalities are not defined by integers (e.g., they may exist in the form of fractals). The ferromagnetic particles are generally in powder form and may exist in the form of spheres, flakes, fibers, whiskers, or the like, or combinations comprising at least one of the foregoing forms. These particles may have cross-sectional geometries that may be circular, ellipsoidal, triangular, rectangular, polygonal, or combinations comprising at least one of the foregoing geometries. The particles as commercially available may exist in the form of aggregates or agglomerates. An aggregate comprises more than one ferromagnetic particle in physical contact with one another, while an agglomerate comprises more than one aggregate in physical contact with one another.

The ferromagnetic particles are particles of iron or iron alloys such as iron-silicon (Fe—Si), iron-aluminum (Fe—Al), iron-silicon-aluminum (Fe—Si—Al), iron-nickel (Fe—Ni), iron-cobalt (Fe—Co), iron-cobalt-nickel (Fe—Co—Ni), or the like, or combinations comprising at least one the foregoing iron alloys. In addition, the aforementioned alloys may comprise phosphorus and boron. While iron alloys generally have a higher permeability and lower core losses when compared with pure iron, pure iron provides a higher induction (high B), is softer and hence is easier to compact to high density and is lower in cost.

In one embodiment, the ferromagnetic particles derived from iron alloys are particles of low carbon steel comprising carbon and manganese, preferably less than 0.2 weight percent (wt %) carbon (C) and less than 1 wt % manganese; Fe—Si alloy preferably containing less than 3.5 wt % silicon (Si); Fe—Al alloy containing preferably less than 10 wt % Al, Fe—Co alloy of composition comprising about 49 wt % Fe, 49 wt % Co and 2 wt % vanadium (V); Fe—Ni alloy comprising about 55 wt % Fe and 45 wt % Ni. The preferred ferromagnetic particles are those obtained from high purity iron (100 wt % Fe).

It is generally desirable for the ferromagnetic particles to have an average particle size as determined by the average mass radius of gyration of about 10 to about 1000 micrometers (μm) prior to coating and compaction. Within the aforementioned range for average particle sizes, it is desirable to have an average particle size of greater than or equal to about 20, preferably greater than or equal to about 50, and more preferably greater than or equal to about 100 μm. Also desirable within this range is a particle size of less than or equal to about 900, preferably less than or equal to about 500, and more preferably less than or equal to about 300 μm.

If the ferromagnetic particles are fibrous, it is generally desirable to have an aspect ratio greater than or equal to about 2, preferably greater than or equal to about 10, preferably greater than or equal to about 50, and more preferably greater than or equal to about 100. It is generally desirable for the fibrous ferromagnetic particles to have an average length of about 3 to about 25 millimeter (mm). Within this range, particles having average lengths of greater than or equal to about 4, preferably greater than or equal to about 10 mm may be used. Also desirable within this range, are average particle lengths of less than or equal to about 15 mm, preferably less than or equal to about 12 mm. For fibrous particles, an average diameter of about 10 to about 2,000 μm may be used. Within this range, a diameter of greater than or equal to about 50, and more preferably greater than or equal to about 200 μm may be used. Also, desirable within this range are diameters of less than or equal to about 500, preferably less than or equal to about 350, and more preferably less than or equal to about 250 μm.

When platelet shaped particles are used, it is generally desirable to have an average thickness of 10 to about 100 μm. Within this range, the average thickness may be greater than or equal to about 15, and more preferably greater than or equal to about 20 μm may be used. Also desirable within this range are average thicknesses of less than or equal to about 90, preferably less than or equal to about 80, and more preferably less than or equal to about 75 μm. The platelet average diameter or characteristic length may be in an amount of about 0.25 to about 5 millimeter (mm). Within this range it is preferable to use platelets having a diameter or characteristic length of greater than or equal to about 0.35, preferably greater than or equal to about 0.45 mm. Also desirable are diameters or characteristic lengths of less than or equal to about 4.5, preferably less than or equal to about 4.0 mm.

The ferromagnetic particles may optionally be annealed prior to the development of the conversion coating, thereby improving the magnetic properties of the particles and the composites derived therefrom. This coating process is termed a pre-coating annealing process. The ferromagnetic particles are generally annealed prior to the development of the conversion coating at temperatures of about 500 to about 1200° C., for a time period of about 15 to about 150 minutes. The preferred annealing temperature is about 800° C. for a time period of about 60 minutes. The pre-coating annealing process can be performed in any protective atmosphere, such as, for example argon, nitrogen, hydrogen, or a combination comprising at least one of the foregoing atmospheres. In one embodiment, the pre-coating annealing process can be a decarburizing annealing process that is performed under a standard decarburizing atmosphere to reduce the carbon content in the particulates to lower levels than are found in the ferromagnetic particles prior to the annealing treatment. Carbon levels can be reduced to as low as 0.0002 wt % depending on the decarburizing process conditions and the carbon level of the starting material.

The ferromagnetic particles may also be optionally degreased using a solvent following which these particles may be cleaned of all metal oxides by using a dilute aqueous solution of an inorganic acid or an inorganic salt in water. Examples of solvents used for the degreasing are acetone, methyl ethyl ketone, toluene, alcohols such as methanol, ethanol, isopropanol, butanol, or the like, N,N dimethylformamide, hexane, or combinations comprising at least one of the foregoing solvents. The preferred solvent is acetone.

Examples of inorganic acids used for removing the oxides are hydrochloric acid, nitric acid, sulfuric acid, or the like, or combinations comprising at least one of the foregoing acids. The preferred acid is hydrochloric acid. Examples of inorganic salts are potassium nitrate, sodium chlorate, sodium bromate, or the like, or combinations comprising at least one of the foregoing inorganic salts. The preferred inorganic salt is potassium nitrate. It is generally desirable to have a solution comprising at least 0.1 to about 50 grams per liter (g/l) of the acid or salt in the water. Within this range, it is desirable to have an amount of greater than or equal to about 0.5 g/l. Also desirable within this range is an amount of less than or equal to about 25, preferably less than or equal to about 10 g/l.

Other additives such as oxidizing agents, surfactants, accelerators, and the like may also be optionally added to the aqueous solution to facilitate the cleaning of the ferromagnetic particles. Examples of organic oxidizing agents suitable for use in the aqueous solution include sodium m-nitrobenzene, nitrophenol, dinitrobenzene sulfonate, p-nitrobenzoic acid, nitrophenol nitroguanidine, nitrilloacetic acid, or the like, or combinations comprising at least one of the foregoing oxidizing agents. If organic oxidizers are used, it is desirable to use them in an amount of about 0.3 to about 10 g/l. Within this range, it is desirable to use an amount of greater than or equal to about 0.5 g/l. Also desirable within this range is an amount of less than or equal to about 2.5 g/l. Alternatively, (or additionally), phosphoric acid may optionally be used in an amount of about 0.1 to about 5 g/l of the aqueous solution.

Examples of surfactants that may be used are sodium dodecyl benzyl sulfonate, lauryl sulfate, oxylated polyethers, ethoxylated polyethers, or the like, or combinations comprising at least one of the foregoing surfactants. Surfactants may generally be used in an amount of up to about 0.5 g/l of the aqueous solution. Within this range it is generally desirable to use the surfactants in an amount of greater than or equal to about 0.1 g/l of the aqueous solution.

The aqueous solution should preferably have a temperature of up to about 60° C. Within this range it is generally desirable to use a solution temperature of greater than or equal to about 25° C. Also desirable within this range is a solution temperature of less than or equal to about 50° C. The treating step is preferably performed for a time period effective to permit the pH of the aqueous solution to come to equilibrium. When a pH change occurs, it is generally desirable to limit the pH change to about 20% of the initial pH value. The pH starting value of the solution depends on the detailed chemistry of the aqueous solution. However, in preferred aqueous solutions, the starting value of the pH is from about 5 to about 6. An exemplary pH change in the aqueous solution would involve an increase from a starting pH of about 5.5 to and end point pH of about 6.1 to about 6.5.

The inorganic particles may finally be rinsed with water to substantially remove all traces of the aqueous solution followed by drying the particles. The process optionally comprises a chromate, molybdate or nitrate rinse to inhibit subsequent oxidation of the coated particles.

The order of the annealing process and the cleaning process are reversible, i.e., either process may be carried out first as desired. In one exemplary embodiment, when high aspect ratio particles are used, the particles are first annealed to a temperature of 800° C. for a period of about 30 minutes to about 90 minutes.

It is generally desirable for the coating on the ferromagnetic particles to exhibit a number of properties, some of which are listed below. It is desirable for the coating to be as thin as possible while at the same time insulating adjacent particles from each other such that an insulation value of about 0.5 to about 20 milli-Ohm-centimeters is achieved in a part fabricated therefrom.

The coating should preferably permit adjacent particles to bind together with sufficient force that a part made by compacting the ferromagnetic particles has sufficient transverse rupture strength so that good mechanical properties can be achieved via compaction without any simultaneous or subsequent sintering after compaction. As used above, “sufficient transverse rupture strength” should be construed as meaning a transverse rupture strength of about 50 mega Pascals (MPa) to about 130 MPa, and preferably at least about 95 MPa as determined in accordance with the protocol of the American Society of Test Materials (ASTM) MPIF Standard 41.

The coating on the ferromagnetic particles should preferably exhibit lubricating properties, particularly during the initial stages of the compaction operations. This lubricating feature should optimally permit the particles to slide by each other during molding, thereby minimizing or eliminating point-to-point welding of the ferromagnetic particles. As a result, a denser, and hence stronger, soft magnetic article is obtained. Additionally, this lubricating property facilitates the ejection of the soft magnetic article from the die thereby decreasing overall manufacturing time and hence reducing manufacturing costs.

The coating preferably has an electrical insulation value that does not substantially degrade when it is subjected to temperatures of greater than about 150° C. The coating on the ferromagnetic particles should also preferably be able to withstand relatively low temperatures, i.e. temperatures of about −60° C. to about 0° C., without degradation or embrittlement of the coating. Examples of such environments are found in colder climates and jet airplanes.

The ferromagnetic particles are coated with a coating that substantially comprises iron oxide in the magnetite (Fe₃O₄) form. This coating is termed a “Black Oxide” and the process is generally called Black Oxide, Blackening, Oxidizing, Oxiding, Steam Bluing, Black Passivating, or Gun Bluing, in the trade. The coating is also termed a conversion coating. In an exemplary embodiment, coatings of the ferromagnetic particles may be done in-situ or may be applied in a separate process. In an in-situ process the coating is developed on the ferromagnetic particles during the process of manufacturing the particles. When applied in a separate process, the ferromagnetic particles are generally coated after a annealing process and/or a cleaning process as detailed above.

In one embodiment, the ferromagnetic particles may be coated by immersing the ferromagnetic particles in an alkaline aqueous salt solution operated at about 140° C. The reaction between the iron of the ferromagnetic particles and the hot oxide bath produces a magnetite coating on the surface of the particles. It is also possible to oxidize non-ferrous metals present in iron alloys under suitable conditions to form Black Oxides. In another embodiment, Black oxide can be produced on the ferrous particles using a molten salt bath operating at a temperature of greater than or equal to about 315° C.

The five basic steps for the formation of Black Oxide conversion coating on ferromagnetic particles comprise cleaning the particles; rinsing the particles; conversion coating the particles; rinsing the particles; optional supplementary coating of the particles if desired. If rust or scale is still present on the particles after the cleaning, additional steps such as acid pickling or alkaline de-scaling, as detailed above, may have to be added before conversion coating. The conversion coating has a thickness of about 0.01 to about 10 μm. Within this range, it is generally desirable to have a thickness of less than or equal to about 7, preferably less than or equal to about 5, preferably less than or equal to about 1 μm, preferably less than or equal to about 0.8, preferably less than or equal to about 0.5, and more preferably less than or equal to about 0.4 μm.

The conversion coating has a weight of less than or equal to about 0.05 to about 0.5 wt %, based on the total weight of the soft magnetic composition. Within this range it is desirable for the conversion coating to have a weight of less than or equal to about 0.45, preferably less than or equal to about 0.35, preferably less than or equal to about 0.25, and more preferably less than or equal to about 0.125 wt % based on the total weight of the soft magnetic composition. In an exemplary embodiment, the conversion coating covers at least 50% of the total surface area of the ferromagnetic particles. It is generally desirable to cover an amount of greater than or equal to about 60, preferably greater than or equal to about 70, and more preferably greater than or equal to about 90% of the total surface area of the ferromagnetic particles.

The coated ferromagnetic particles may optionally be coated with an additional coating if desired. The additional coating may comprise a metal oxide or a polymeric resin or a combination of metal oxide and a polymeric resin. Examples of suitable metal oxides that may be used if desired comprise an amount of about 40 to about 85 wt % and preferably an amount of about 65 to about 80 wt % of either iron oxides such as FeO, Fe₃O₄, Fe₂O₃, (Fe₂O₃.H₂O) or combinations comprising at least one of the foregoing iron oxides with about 15 to about 60 wt %, and preferably from about 20 to about 35 wt % of iron complexes such as FePO₄, Fe₃(PO₄)₂, FeHPO₄, FePO₄.2H₂O, Fe₃(PO₄)₂.8H₂O, FeCrO₄, FeMoO₄, FeC₂O₄, FeWO₄, or combinations comprising at least one of the foregoing. When an iron oxide/phosphate coating is used as the coating on the ferromagnetic particles, the weight ratio is preferably selected so that the composition of the coating approximates that of the mineral Vivianite (i.e., Fe₃O₄+Fe₃(PO₄)₂.8H₂O) and hence comprises a “Vivianite-like” material. In one embodiment, the additional coating is substantially free of organic materials.

In another embodiment, the additional coating comprises organic materials such as polymeric resins. While the polymeric resin for the additional coating are generally selected based on its thermal stability at temperatures of greater than or equal to about 200° C., polymers having stability at lower temperatures may be utilized for lower temperature applications. Silicone polymers are examples of polymers that can withstand elevated temperatures i.e., it generally forms a silicate, silicon carbide, silicon nitride or a Si—O—C network upon decomposition at temperatures of greater than or equal to about 500° C. and is therefore desirable as a coating. The polymeric resin may be selected from a wide variety of thermoplastic resins, thermosetting resins, blends of thermoplastic resins, or blends of thermoplastic resins with thermosetting resins. The polymeric resin may also be a blend of polymers, copolymers, terpolymers, dendrimers, ionomers or combinations comprising at least one of the foregoing polymeric resins. Specific examples of thermoplastic resins include polyacetals, polyacrylics, polycarbonates, polystyrenes, polyolefins, polyurethanes, polyesters, polyamides, polyamideimides, polyarylates, polyurethanes, polyarylsulfones, polyethersulfones, polyarylene sulfides, polyvinyl chlorides, polysulfones, polyetherimides, polytetrafluoroethylenes, polyetherketones, polyether etherketones, and combinations comprising at least one of the foregoing polymeric resins.

Specific examples of blends of thermoplastic resins include acrylonitrile-butadiene-styrene/nylon, polycarbonate/acrylonitrile-butadiene-styrene, polyphenylene ether/polystyrene, polyphenylene ether/polyamide, polycarbonate/polyester, polyphenylene ether/polyolefin, and combinations comprising at least one of the foregoing blends of thermoplastic resins.

Specific examples of polymeric thermosetting materials include polyurethanes, natural rubber, synthetic rubber, epoxy, phenolic, polyesters, polyamides, silicones, and mixtures comprising any one of the foregoing thermosetting resins. Blends of thermosetting resins, as well as blends of thermoplastic resins with thermosetting can also be utilized. The preferred polymeric resin is one that comprises a silicone polymer or copolymer.

The insulating polymeric resinous coating can be coated on the particles using any coating process, such as spraying, vapor deposition, dipping, fluidized bed coating, precipitation coating, or a combination thereof. Where the insulating material is a metal oxide, the coating can be formed by applying a metal film to the ferromagnetic particle and then oxidizing the metal film to make a metal oxide. Where the insulating material is silicone polymer, it can be dissolved in xylene solvent to make a silicone solution and then the particles are dipped in the solution. The solvent is evaporated off by application of vacuum and/or heat, leaving a silicone coating on the particles. In an exemplary embodiment, the coated ferromagnetic particles having the additional polymeric resinous coating may be subjected to annealing at a temperature above the degradation point of the polymeric resin. Such a process may be used to form a coating comprising a silicate, silicon carbide, silicon nitride or a Si—O—C network on the surface of the coated ferromagnetic particles.

The optional additional coating has a weight of less than or equal to about 0.05 to about 0.5 wt %, based on the total weight of the soft magnetic composition. Within this range it is desirable for the optional additional coating to have a weight of less than or equal to about 0.45, preferably less than or equal to about 0.35, preferably less than or equal to about 0.25, and more preferably less than or equal to about 0.125 wt % based on the total weight of the soft magnetic composition.

The optional additional coating has a weight of less than or equal to about 0.2 wt %, based on the total weight of the soft magnetic composition. Within this range, it is desirable for the optional additional coating to have a weight of greater than or equal to about 0.01, preferably greater than or equal to about 0.02, and more preferably greater than or equal to about 0.05 wt %, based on the total weight of the soft magnetic composition. Also desirable within this range is an optional additional coating having a weight of less than or equal to about 0.18, preferably less than or equal to about 0.15, and more preferably less than or equal to about 0.1 wt % based on the total weight of the soft magnetic composition.

As stated above, the coated ferromagnetic particles are compacted into a desired shape to form a desired article. Suitable examples of compaction techniques include uniaxial compaction, isostatic compaction, injection molding, extrusion, and hot isostatic pressing. A low compaction pressure results in a poor density of the compact. A high compaction pressure results in excessive residual stresses being induced in the compact. A suitable range for compaction pressure is about 250 MPa (mega-Pascals) to about 1,500 MPa. Within this range it is generally desirable to use a compaction pressure of greater than or equal to about 300, preferably greater than or equal to about 600, and more preferably greater than or equal to about 800 MPa. Also desirable within this range is a compaction pressure of less than or equal to about 1,300, preferably less than or equal to about 1,250, and more preferably less than or equal to about 1,200 MPa. The most preferred compaction pressure is about 1,000 MPa to about 1,200 MPa.

The density of the composite magnetic article is greater than about 90% of the true density of the ferromagnetic core material. The ferromagnetic core material are the ferromagnetic particles as detailed above. It is generally desirable for the composite magnetic article to have a density of about 90 to about 97% of the true density of the ferromagnetic core material. Defects such as pores in the composite magnetic article affect the transport of magnetic flux and, therefore, reduce permeability. A decrease in the porosity increases the density of the compact and results in an increase in the permeability. During the compaction process, stresses are introduced into the encapsulated ferromagnetic particles, which are subsequently relieved by subjecting the compact to a high temperature annealing treatment.

The coated ferromagnetic particles are then subjected to an annealing process after the coating and compaction. This annealing process is conducted for purposes of relieving stresses in the coated particles. This annealing process is conducted on the coated particles after compaction, when the ferromagnetic particles exist in the form of an article.

Thermal treatment of coated ferromagnetic particles is typically performed in a tray oven, or a high temperature furnace. In one embodiment, the thermal treatment is carried out in an inert atmosphere such as a nitrogen or argon atmosphere. In another embodiment, the thermal treatment is performed in a reactive atmosphere such as air. In general, the thermal treatment is performed at a thermal treatment temperature of about 250° C. to about 950° C. Within this range, it is generally desirable to use a temperature greater than or equal to about 300, preferably greater than or equal to about 350, and more preferably greater than or equal to about 400° C. Also desirable within this range is a temperature of less than or equal to about 900, preferably less than or equal to about 800, and more preferably less than or equal to about 700° C. The most preferred temperature for annealing after compaction is about 500° C. when a black oxide coating is utilized, while when a black oxide coating with an additional coating of silicone polymer is utilized, an annealing temperature of 700° C. is used. The coated ferromagnetic particles are generally annealed for about 15 minutes to about 4 hours. Within this range an annealing time of less than or equal to about 3, preferably less than or equal to about 2 hours is desirable. The most preferred annealing time is about 15 to 60 minutes.

In another embodiment, the articles comprising the compacted particles are subjected to an annealing treatment that comprises a first annealing treatment and an optional second annealing treatment. This annealing is performed for stress relief in the compacted article. The first annealing treatment is performed at a temperature of greater than or equal to about 500° C. for a first annealing time period of about 15 minutes to about 4 hours. The preferred first annealing temperature is about 700° C. The second annealing treatment is optional and is performed at a temperature lower than that at which the first annealing is performed. Preferred temperatures for the optional second annealing is about 300 to about 500° C. for a period of greater than about fifteen minutes. The second annealing time period is dependent on the desired properties of the composite magnetic article. Relevant properties include permeability and core loss. The extent and magnitude of the residual stresses present in the compact also have a bearing on the second annealing time period.

The articles derived by the aforementioned processes display a number of advantages. The magnetite coating provides an electrical insulation for individual ferromagnetic particles to reduce eddy current losses and may also serve as a binder or a lubricant. The desired properties in magnetic core articles made using magnetite coated ferromagnetic powders include high density, high permeability, low core losses, high transverse rupture strength, and suitability for compaction techniques. The properties of magnetic core articles, made using magnetite coatings provide significant advantages particularly at low frequency operation where low-core losses are particularly advantageous. Annealing the magnetic core article can result in increased permeability and lower core losses. Annealing relieves residual stresses caused by compaction of the encapsulated ferromagnetic powders.

The advantageous properties of the soft magnetic composites permit them to be utilized in a variety of applications. Examples of such applications include electromagnetic parts such as stators, rotors, actuators, armatures, solenoids and motors used in the engine compartment of gasoline or diesel motors. In addition, magnetic parts made from the coated ferromagnetic particles can be annealed at relatively high temperatures of about 250 to 500° C.

The following examples, which are meant to be exemplary, not limiting, illustrate compositions and methods of manufacturing of some of the various embodiments of the soft magnetic compositions and articles described herein.

### EXAMPLE 1

Water atomized iron powder (Ancorsteel 1000C) of average particle size 100 μm was degreased using acetone. The surface of the powder was cleaned of oxide using 5 wt % hydrochloric acid solution in water. The traces of hydrochloric acid were removed by rinsing in water. Commercial low temperature black oxide chemicals were used for depositing black oxide coating. The alkaline bath temperature was maintained between 140 to 150° C. for 1 minute and contains potassium nitrate or nitrite. The coated particles were filtered off and washed to remove the alkaline coating solution. The washed powder was dried at 105 to 110° C. The coated particles was compacted in a uni-axial press, using zinc stearate as die lubricant, at a pressure of 1,220 MPa to obtain toroidal rings having dimensions of 3.42 centimeter (cm) (outer diameter), 2.54 cm (inner diameter) and 0.635 cm height. The green density of the rings was 7.57 grams per cubic centimeter (g/cm³). The green compacts were annealed at 500° C. for 30 minutes in flowing nitrogen atmosphere. The AC permeability and core loss of the annealed toroidal ring were measured as per ASTM A912-93 standards. The peak permeability and permeability at 1 Tesla (T) were found to be 520 and 400, respectively at 60 Hz. The core loss at 60 Hz and 1 T was measured to be 8.8 Watts per kilogram (W/kg). The hysteresis and eddy current losses at 60 Hz and 1 T were found to be 7.7 and 1.1 W/kg, respectively.

The microstructure of the compact made of black oxide (magnetite) coated particles is given in the FIGURE. The coating coverage and thickness were measured by metallographic technique and found to be 78% and 0.4 millimeter (mm), respectively. The resistivity was measured by making cylindrical pellets of 1.60 cm diameter and 0.508 cm thickness. The pellets were made according to process conditions described for toroidal ring, i.e. 1220 MPa compaction pressure and annealing temperature of 500° C. for 30 minutes in flowing nitrogen gas. The resistivity was measured on the pellets by the Vander Pauw method. The measured value of resistivity was 0.33 milli-Ohm-cm.

The transverse rupture strength of the compacts made of black oxide coated powders was measured as per MPIF standard 41. Cuboidal specimens having the dimension of 3.175 cm (length)×1.27 cm (width)×0.635 cm (thickness) were prepared using process conditions similar to toroidal rings. The density of the compact was found to be 7.44 g/cm³. A transverse rupture strength of 100 MPa was measured for the compacts.

### EXAMPLE 2

Black oxide coating was applied on the iron powder (particles) of 300 micrometer average particle size according to the process mentioned in example 1. The coated particles were compacted at 1220 MPa in the shape of toroidal ring of dimension given in example 1. The density of the green compact was measured to be 7.63 g/cm³. The compacted ring was annealed in flowing nitrogen gas at 500° C. for 30 minutes. The alternating current (AC) permeability of the toroidal ring was measured as per ASTM A912-93 standard. The peak permeability and permeability at 1 Tesla were found to be 560 and 530, respectively at 60 Hz. The AC core loss was measured to be 18.26 W/kg at 1 T and 60 Hz. The hysteresis and eddy current losses at 1 T and 60 Hz were found to be 11.66 and 6.6 W/kg, respectively.

### EXAMPLE 3

Low carbon steel particles comprising 0.06 wt % C and 0.24 wt % manganese (Mn) and having a cylindrical shape (rods), with a diameter of 0.0254 cm and a length of 0.9525 cm were annealed at 800° C. for 1 hour in high purity flowing nitrogen gas. Black oxide coating was then applied to these particles in the same manner as described in Example 1. The particles were compacted in the form of standard toroidal ring required for testing magnetic properties as per ASTM standard A912-93. The compaction pressure used for making the toroids was 1220 MPa. The green density of the toroid was measured to be 7.78 g/cm³. The toroid was annealed at 500° C. for 30 minutes. The AC peak permeability and permeability at 1 Tesla were measured to be 1190 and 1000, respectively at 60 Hz. The AC core loss at 60 Hz and 1 T was found to be 13.42 W/kg, which had contribution of 7.48 W/kg from hysteresis loss and 5.94 W/kg from eddy current loss at 1 T and 60 Hz.

### EXAMPLE 4

Low carbon steel particles of cylindrical shape, with a diameter of 0.0254 cm and length of 0.9525 cm were taken as the starting material for making soft magnetic composite. The particles were subjected to decarburization annealing treatment at 780° C. for 45 minutes. The purpose of decarburization annealing was three-fold. Firstly, it removes the stresses introduced during particle fabrication and makes the particles compressible. Secondly, the heat treatment reduces the carbon level in the iron, low carbon levels are favored for high magnetic permeability. Thirdly, unintentional presence of oxygen in the treatment leads to formation of insulating oxide mixtures consisting of magnetite, haematite and wustite giving a blue appearance to the powder surface. In this example, the said effects were exploited for developing materials of high permeability. The decarburized annealed particles were compacted in the form of standard toroidal rings as per ASTM standard employing a uni-axial compaction pressure of 1220 MPa. The green density of the ring was measured to be 7.65 g/cm³. The ring was annealed at 500° C. for 30 minutes in the flowing nitrogen. The magnetic properties were tested as per ASTM standard A 912-93. The peak permeability and permeability at 1 Tesla were found to be 1640 and 1540, respectively at 60 Hz. The core loss at 1 T and 60 Hz was 7.92 W/kg. The hysteresis and eddy current loss of core loss were measured to be 6.6 and 1.54 W/kg at 1 T and 60 Hz, respectively.

In yet another experiment, the low carbon steel particles were subjected to decarburized annealing at 780° C. for 45 minutes followed by silicone coating. The silicone used for the coating had a high solid content of greater than or equal to about 75 wt %. For coating the particle surfaces with silicone, a desired mass of silicone was dissolved in xylene. The weight ratio of xylene to silicone was 30:1 (ml:gram). The particles were dipped in the silicone solution and kept in suspension by stirring. The xylene was boiled off by application of temperature (95° C.) and vacuum (170 mbar). This process left behind a thin layer of silicone coating on the particles. The particles were compacted at 1220 MPa in the form of toroidal ring as described in Example 1. The green density of the toroidal ring was found to be 7.65 g/cm³. The toroidal ring was annealed in nitrogen atmosphere at 700° C. for 30 minutes. This facilitated stress relieving and also decomposed the silicone to Si—O—C electrically insulating network. The peak permeability and permeability at 1 Tesla were found to be 2770 and 1960, respectively at 60 Hz. The core loss at 1 T and 60 Hz was measured to be 4.4 W/kg. The hysteresis loss and eddy current loss components of the core loss were measured to be 3.52 and 1.1 W/kg, respectively at 1 T and 60 Hz. The eddy current loss for the additional silicone coated samples was not found to be significantly different from the particles subjected to decarburization annealing alone. This corroborates the existence of insulating coating after decarburization annealing sufficient for reducing the eddy current loss.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A composition comprising:
ferromagnetic particles having a magnetite coating.

2. The composition of claim 1, wherein the ferromagnetic particles comprise iron or iron alloys.

3. The composition of claim 2, wherein the iron alloys comprise iron-silicon, iron-aluminum, iron-silicon-aluminum, iron-nickel, iron-cobalt, iron-cobalt-nickel or combinations comprising at least one the foregoing iron alloys.

4. The composition of claim 1, wherein the ferromagnetic particles comprise iron and wherein the particles are platelets, fibers, particulates, rods, or combinations comprising at least one of the foregoing.

5. The composition of claim 1, wherein the ferromagnetic particles consist essentially of iron.

6. The composition of claim 1, wherein the ferromagnetic particles comprise iron and wherein the particles have fractal geometries.

7. The composition of claim 1, wherein the ferromagnetic particles comprise water atomized iron.

8. The composition of claim 1, wherein the ferromagnetic particles have an average particle size as determined by the average mass radius of gyration of about 10 to about 1,000 micrometers prior to coating and compaction.

9. The composition of claim 1, wherein the ferromagnetic particles have an aspect ratio of greater than or equal to about 2.

10. The composition of claim 1, wherein the ferromagnetic particles have an aspect ratio of greater than or equal to about 10.

11. The composition of claim 1, wherein the ferromagnetic particles are fibers having an average length of about 3 to about 25 millimeters.

12. The composition of claim 1, wherein the ferromagnetic particles are fibers having an average diameter of about 10 to about 2000 micrometers.

13. The composition of claim 1, wherein the magnetite coating has a thickness of about 0.1 to about 2 micrometers.

14. The composition of claim 1, wherein the composition comprises magnetite in an amount of less than or equal to about 0.2 wt %, based on the total weight of the composition.

15. The composition of claim 1, wherein the magnetite coating covers at least 50% of the surface area of the ferromagnetic particles.

16. The composition of claim 1, wherein the composition comprises an additional coating of a metal oxide or a polymeric resin or a combination comprising at least one of the foregoing coatings.

17. The composition of claim 1, wherein the composition comprises an additional coating comprising a silicate, silicon carbide, silicon nitride or a combination comprising at least one of the foregoing coatings.

18. The composition of claim 1, wherein the composition comprises an additional coating comprising a Si—O—C network.

19. The composition of claim 18, wherein the additional coating is disposed upon the magnetite coating

20. An article manufactured from the composition of claim 1.

21. A method comprising:
coating ferromagnetic particles with magnetite; and
compacting the particles to a desired shape.

22. The method of claim 21, further comprising annealing the shape.

23. The method of claim 21, further comprising cleaning the ferromagnetic particles prior to coating the particles.

24. The method of claim 21, wherein the coating covers at least 50% of the surface area of the ferromagnetic particles.

25. The method of claim 21, wherein the pressure applied during compaction is about 250 to about 1,500 mega Pascals.

26. The method of claim 21, wherein the ferromagnetic particles are further coated with a polymeric resin, and wherein the polymeric resin is silicone.

27. The method of claim 26, wherein the ferromagnetic particles are further annealed to convert the silicone to a network comprising silicate, silicon carbide, silicon nitride or a combination comprising at least one of the foregoing networks.

28. The method of claim 26, wherein the ferromagnetic particles are further annealed to convert the silicone to a Si—O—C network.

29. An article manufactured from the method of claim 21.
